(19) United States
(12) Patent Application Publication
(10) Pub. No.: US 2022/0153284 A1
(43) Pub. Date: May 19, 2022

(54) METHOD, SYSTEM AND ELECTRONIC COMPUTING DEVICE FOR CHECKING SENSOR DEVICES OF VEHICLES, IN PARTICULAR OF MOTOR VEHICLES

(71) Applicant: AUDI AG, Ingolstadt (DE)

(72) Inventors: Erich BRUNS, Ingolstadt (DE); Moritz VENATOR, Ingolstadt (DE)

(73) Assignee: AUDI AG, Ingolstadt (DE)

(21) Appl. No.: 17/254,478

(22) PCT Filed: Jul. 4, 2019
(86) PCT No.: PCT/EP2019/067991

§ 371 Date: Dec. 21, 2020

(30) Foreign Application Priority Data
Jul. 24, 2018 (DE) 10 2018 212 249.0

(51) Int. Cl. B60W 50/02; G07C 5/00; G06V 20/56; G06V 20/58; G06V 10/98

(52) U.S. Cl. CPC B60W 50/0205; G07C 5/008; B60W 2050/0083; G06V 20/582; G06V 10/98; G06V 20/588

(57) ABSTRACT

A method for testing sensor devices of vehicles, including acquiring, by central processor device, first data items which are made available by a first vehicle of the vehicles. The first data items have at least one property of a positionally fixed object, which is sensed by the sensor device of the first vehicle, and a location, determined by the first vehicle, of the object, on the earth; acquiring second data items, made available by a second of the vehicles, the processor device, The second data items have the at least one property of the positionally fixed object which is sensed the sensor device of the second vehicle and a location, determined by the second vehicle, of the object on the earth; and checking the sensor devices in accordance with the first data items and the second data items.

The invention relates to a method, a system and an electronic computing device for checking sensor devices of vehicles, in particular motor of vehicles, e.g., automobiles.

DE 10 2010 063 984 A1 discloses a sensor system with several sensor elements, which are designed such that they at least partially detect different primary variables and at least partially use different measuring principles.

A method for improved detection and/or compensation of error values is known from DE 10 2014211 180A1.

Furthermore, DE 10 2012 216 215 A1 discloses a sensor system with several sensor elements and a signal-processing device.

The object of the present invention is to provide a method, a system and an electronic computing device, wherein vehicle sensor devices can be checked, in particular evaluated, in a particularly advantageous manner.

This object is achieved according to the invention by a method having the features of claim 1, by a system having the features of claim 10, as well as by an electronic computing device having the features of claim 11. Advantageous embodiments with appropriate developments of the invention are specified in the remaining claims.

A first aspect of the invention relates to a method for checking, in particular evaluating vehicle sensor devices. The method according to the invention comprises a first step, in which data provided by a first vehicle of the vehicles are initially detected, i.e., received, by a central electronic computing device, which is external to the vehicles. This means that the first vehicle provides the first data, in particular wirelessly, i.e., for example via a wireless data link, and transmits it to the electronic computing device. The electronic computing device receives, e.g., the first data wirelessly, i.e., via a wireless data link. In particular, the electronic computing device receives, e.g., the initial data via the Internet. The first vehicle has a first sensor of the sensor devices, such that the first sensor device is a part or a component of the first vehicle. The first data characterize at least one property of a stationary or fixed object detected by the first vehicle sensor device, in particular an environment of the first vehicle.

The feature of the electronic computing device being external to the vehicles means that the electronic computing device is not a part, i.e., not a component of the vehicles. In other words, the electronic computing device is neither a component of the first vehicle, nor a component of the second vehicle. For this reason, the electronic computing equipment is also referred to as a server, a backend server, or simply a backend. However, the first sensor device is a component of the first vehicle,

In a second step of the method according to the invention, second data provided by a second vehicle of the vehicles are detected or received by the central electronic computing device, which is external to the vehicles. In this case, the second vehicle includes a second sensor device of the sensor devices to be checked, such that the second sensor device is a part or a component of the second vehicle. In contrast, however, the first vehicle or first sensor device is external to the second vehicle, such that the first vehicle or first sensor device is not a part or a component of the second vehicle. Conversely, the second vehicle or sensor device is external to the first vehicle, such that the second vehicle or sensor device is not component of the first vehicle.

The second data characterize at least one property of the fixed or stationary object detected by the second sensor device of the second vehicle. The first data characterize a location of the earth-based object determined by the first vehicle. In addition, the second data characterize a or the location of the earth-based object determined by the second vehicle. If the location of the earth-based object determined by the first vehicle, in particular by the first sensor device, matches the locations of the earth-based object determined by the second vehicle, in particular the second sensor device, it can thereby be ensured that the sensor devices have detected the same object in the respective vehicle environment. As a result, the sensor devices can be checked particularly advantageously by using the object, and in particular the at least one property.

To this end, the inventive method comprises a third step, wherein the sensor device is checked, in particular assessed or evaluated, depending on the first data and the second data.

The feature that both the first and the second data characterize the at least one property of the object signifies in particular that the first and the second data characterize the per-se same property. It is conceivable that the first data characterize a first expression of the at least one property, and the second data characterize a second expression of the at least one property, whereby the first expression may match the second expression, or the expressions may differ from one another. If, for example, the first expression matches the second expression, or the expressions are identical, there is no significant difference between the sensor devices. In particular, it can be concluded that the sensor devices are functional and able to detect the object and in particular its property, and in particular here the expression of the property in a desired way. If, however, the expressions differ from one another, it can be concluded that one of the sensor devices detects the at least one property or its expression correctly, or as desired, whereas the other sensor device is unable to correctly detect the at least one property and in particular its expression. Thus, the method according to the invention makes it possible to draw a particularly efficient and effective conclusion as to the functional capability and/or performance of the sensor devices, specifically regarding the capability of detecting at least one property and in particular its expression, as it really is.

In an advantageous embodiment of the invention, this first sensor device of the first vehicle is associated with a first sensor-device type, and the second sensor device of the second vehicle is associated with a second sensor-device type, which is different from specifically the first sensor-device type. This is the most efficient and effective way to detect and subsequently, if required, correct for any differences between the types of sensor setup, in particular as regards its ability to correctly detect the expression of at least one property, as it really is. This, in particular, means that the at least one property of the object has an actual expression, which would be recognized or detected by, e.g., a person, in particular via optical perception or detection of the at least one property. If the respective expression of the at least one property detected by the respective sensor device corresponds to the actual expression, the expression of the at least one property will be correctly detected by the respective sensor device. If, however, the expression of the at least one property detected by the respective sensor device differs from the actual expression, the respective sensor device displays an error or a need for remediation with regard to the detection of the expression or the detection of the at least one property.

This can now be recognized particularly advantageously, especially by statistical means, by the method according to the invention. If, for example, the method according to the invention detects that a first number of vehicle sensor devices detects a first expression of the at least one property of the object, wherein a second number of vehicle sensor devices, which is less than the first number, detects a second expression of the at least one property of the object, which differs from the first expression, it can be concluded, depending on the numbers and in particular depending on their ratio, that the first expression matches the actual expression, and that the second expression differs from the actual expression. As a result, steps may be taken, e.g., to improve the sensor devices belonging to the second number in terms of their ability to detect at least one property. In particular, it is possible to evaluate the sensor devices across generations, especially with regard to their ability to detect objects arranged in the environment.

For example, the sensor devices differ from one another in terms of their software generations and/or their components. The method makes it possible to determine, whether and which sensor device type is better or more efficient than another type of sensor equipment in terms of detecting at least one property or its expression. For example, a first of the sensor device types is a first sensor-device generation, while a second of the sensor device types is, e.g., a second sensor-device generation. The sensor-device generations differ from one another in that, e.g., the first sensor-device generation was developed and marketed prior to the second sensor-device generation. The method makes it possible to take steps to make the first sensor-device generation at least almost as good or efficient as the second sensor-device generation in terms of the detection of at least one property or its expression, in particular if the method determines that the second sensor-device generation can correctly detect the expression, while at least some of the devices belonging to the first sensor-device generation cannot do so.

In a further embodiment of the invention, first comparison data are generated from the first data, and second comparison data are generated from the second data, whereby the comparison data are compared with one another, and the sensor devices are checked depending on the comparison and the comparison data. The respective comparison data are or characterize, e.g., a recognition rate with which the expression was correctly detected, in particular by the respective sensor-device generation. By comparing the recognition rates, it can be determined whether or not the sensor-device generations differ substantially in terms of their correct recognition of the expression. If the sensor-device generations differ substantially from one another in terms of their detection rates, it can be inferred that one of the sensor-device generations is more efficient than the other sensor-device generation in terms of their detection of the configuration of the property. As a result, steps may be taken, e.g., to update the older, first sensor-device generation and raise their performance to at least almost the same as the second sensor-device generation. It is also conceivable that the newer, second sensor-device generation will need to be trained first, due to weaknesses resulting from new modified hardware components or software algorithms.

This may be realized, e.g., by using the electronic computing device to request training data of at least one of the vehicle-sensor devices comprising the at least one sensor device, depending on the comparisons of the comparison data. In other words, if, for example, the comparison data vary strongly from one another, and if it is determined, e.g., that the detection rate of the first sensor-device generation is less than the detection rate of the second sensor-device generation, training data of the second sensor-device generation will be requested, e.g., by the electronic computing device, in particular with the aim of improving the detection rate, and hence the performance of the first sensor-device generation. Improving the first sensor-device generation may require training data that was likewise recorded with the help of the first generation. The second-generation result is then used as a (reference truth) label.

It was shown here to be particularly advantageous, if the training data requested and provided by the vehicle comprising at least one sensor device are received by means of the electronic computing device. By means of the received training data, e.g., the at least one sensor device was trained. Therefore, e.g., the at least one sensor device has leamed, i.e., has been trained to detect the at least one property and in particular its expression based on the received training data. It is also conceivable that the training data from the other sensor device is received, e.g., such that the training data can be compared with one another. In this way, e.g., reasons for any differences in the detection rates can be identified in a straightforward and efficient manner. Consequently, steps may be taken, e.g., to at least reduce the difference between the detection rates.

For this purpose, it has proven to be particularly advantageous if, depending on the received training data, data for updating the at least one sensor device are transmitted from the electronic computing device to the vehicle comprising the at least one sensor device. The update data comprise, e.g., new training data that is or was generated from the received training data and possibly from the comparison of the training data. The update data include improved algorithms; the vehicle itself does not have the necessary resources to optimize features based on training data. Training of the algorithms takes place in a central computer device, which is external to the vehicle. The reloaded data are also referred to as an update or update data, such that the at least one sensor device, which was less efficient than the other sensor device in terms of detecting the expression of the at least one property, can be reloaded, i.e., updated. Thus, it can, e.g., be achieved that after updating of the at least one sensor device, the at least one sensor device and the other sensor device have at least almost identical performance as regards their detection of the at least one property.

The property includes, e.g., at least one speed limit and/or at least one lane marking. As for the speed limit, the relevant expression is to be understood as, e.g., a speed indication or value. The above-mentioned first expression is, e.g., 60 KPH, whereas the second expression is 80 KPH. Thus, the actual expression may be, e.g., 60 KPH or 80 KPH. As for road markings, the expression shall mean, e.g., a line marking and/or a dotted or solid traffic line.

Finally, it was shown to be particularly advantageous if the first vehicle and the second vehicle exchange vehicle data, in particular directly. The exchange of vehicle data thus takes place in order to, e.g., enable vehicle-to-vehicle communication (car-to-car communication). Communication may also take place exclusively between the vehicles and the infrastructure, in particular a central backend. The data is received, e.g., via vehicle-to-infrastructure communication, in that the electronic computing equipment belongs to, e.g., an infrastructure. In particular, the electronic computing equipment is stationary or fixed, especially with respect to the earth. In contrast, the vehicles are non-stationary or mobile, and thus movable relative to the earth.

It is provided that at least one of the vehicles transmits the associated data to the electronic computing equipment depending on the vehicle-data exchange. As part of the vehicle-data exchange, the first vehicle transmits, e.g., to the second vehicle that the first sensor device has detected the object. If the second sensor device of the second vehicle subsequently also detects the object, the second vehicle may then, e.g., transmit the second data to the electronic computing device, in that the second vehicle knows that the first vehicle has previously detected the object by means of the first sensor device. The first vehicle may, e.g., transmit the first data to the electronic computing device independently of the exchange of vehicle data, or the second vehicle may, as part of the exchange of vehicle data, inform the first vehicle that the second sensor device has now also detected the object. Subsequently, for example, both the first and the second vehicle transmit the respective data to the electronic computing device. Since the data characterize the location of the earth-based object, it can be ensured that the sensor devices have detected the same object, such that the sensor devices can be compared and, in particular, checked with one another with great precision.

Moreover, the method according to the invention is particularly advantageous in that the respective sensor device or its ability to detect objects in the respective environment is used to enable a driver assistance system and/or at least one automated driving feature. The more efficient the respective sensor device is in terms of its ability to correctly detect objects arranged in the environment of the respective vehicle, and in particular their properties and expressions, the more advantageously the driver assistance system or the automated driving feature can be implemented. As a result, a particularly safe journey can be ensured. The invention is based, in particular, on the following knowledge:

The further development of driver assistance systems and automated driving features requires an ever-increasing amount of information about the vehicle environment, which is detected by sensors, particularly by the respective sensor equipment. The sensors may be camera, radar and/or laser sensors and may detect and classify, e.g., various objects in the vehicle environment. These objects may be other vehicles, pedestrians, traffic signage, lane markings and/or lane boundaries. The sensors provide signals and thus information about the detected objects, whereby this information is received by corresponding control units, in particular for realizing the driver assistance system or the automated driving feature. The detection of objects in the environment by a sensor device is also referred to as environmental perception. Based on such environmental perception, driver assistance features, such as lane-keeping assistance, traffic-sign recognition, and/or an automatic emergency braking feature can then be implemented. As for the development of highly automated driving features, especially on levels 3 to 5, the requirements on the admissibility and performance of the respective sensor device, also referred to as a sensor system, are constantly increasing.

For the evaluation of the performance of sensor devices and thus acceptance functions, in particular, environment perception functions, which are quantified, e.g, in the form of a recognition rate of traffic signs, road markings, lane markings, etc., labeled, i.e., marked, test data sets are used. These contain a so-called associated reference truth, which is also referred to as a ground truth. With the aid of the reference truth, the sensor perception is adjusted and evaluated.

Networking of vehicles via mobile data networks makes it possible to access vehicle-sensor and bus data remotely, either wirelessly or from a distance. The above-described exchange and/or transmission and/or sending and/or receiving of the respective data or vehicle data is thus preferably wireless, i.e., via wireless data connections, such as in particular radio links. For example, image and data streams may be sent to a backend. By processing this so-called swarm data, it becomes possible to gain knowledge, e.g., of the user and system behavior, including environmental conditions, particularly as concerns the weather, road conditions, traffic jams, and the like.

Vehicles with different sensor systems are usually present on the market, which in particular have different generations of sensors and/or software, such that the sensor equipment or generations of sensor equipment of vehicles belonging to the same line of products may also differ from one another. Sensor devices designed as camera systems differ, e.g., in the selection of the so-called image sensor, also referred to as an imager, the lens, the control-unit hardware, the supplier of the image-processing software, the algorithms and their versions. In addition, the different generations and variants are or have been trained or tested and secured with different training and test data. As a result, the performance of the individual types of sensor equipment, also referred to as variants and generations, is at the present time difficult to compare, and usually only subjectively by way of random testing and/or retrieval and labeling of comparable test data sets, which is associated with high costs.

The aforementioned problems and disadvantages can be avoided by the method according to the invention. The invention provides networking of the vehicles via the electronic computing device, also referred to as the backend. Due to this networking of the vehicles via the backend, the performance of the sensor devices, also referred to as the sensor systems of the different vehicles can, e.g., be continuously recorded and compared with one another. To this end, the individual vehicles transmit their detections of static objects, such as traffic signs and lanes or lane markings with associated geopositions in particular to the backend,

The respective geoposition is to be understood as the location of the respective earth-based object. For example, the location is determined by a satellite-based navigation system, in particular GPS (Global Positioning System). Thus, the respective data includes, e.g., location or position data that characterize or indicate the location of the detected object. The location data include, in particular, coordinates, in particular, location coordinates, which indicate a particularly unique position of the detected earth-based object. By means of the backend or within the backend, the data of the different variants and generations are compared with one another. The data transmitted to and received by the backend are results or a result of the detection of at least one property, and in particular its expression by the respective sensor device,

Should the results deviate significantly from one another, then, e.g., training data are specifically requested from the relevant location, i.e., from at least one of the sensor devices to be checked in order to optimize, i.e., improve the at least one sensor device and in particular its relevant algorithms. This improvement of the at least one sensor device means that any differences in the performance of the sensor devices, in particular with regard to the detection and recognition of the expression of the at least one property, are at least reduced or even eliminated.

By means of the method according to the invention, comparative standards for the evaluation of the performance of the sensor devices can be applied across suppliers and/or generations, also known as benchmarks. Scenes or situations in which significant differences between the individual sensor system generations occur can be used as additional training and test data in order to evaluate or optimize the detection or performance of existing and newer sensor systems. This ensures that the quality and performance of older systems or generations of sensor equipment is at least reached or even surpassed by newer generations of sensor equipment. This makes it easier to possibly change suppliers of the involved software and hardware components, and reduces any dependency on individual suppliers or suppliers, Moreover, this increases competition by allowing comparative benchmarks before selection and during development. The method according to the invention is suitable for examining, in particular, evaluating different generations of cameras or camera systems and, in particular, as a general benchmark for sensor equipment, in particular camera systems in vehicles. The above-described reference truth is generated by way of networking the vehicles and a resulting networked fleet of vehicles on real roads. Thus, for example, the expression, which was detected by the highest number of sensor devices, is used as a reference truth. Thus, the method according to the invention offers the novel possibility of objectively comparing different camera systems or sensor devices in real operation.

In a technical implementation, for example, the data representing detection results for static, i.e., locally unchangeable objects, of the individual vehicles or sensor devices, are sent to the backend, received by the backend, and recorded in the backend along with the corresponding location, i.e., for example, with an associated GPS position, in order to later compare the performance of the individual generations and variants.

If, for example, an appropriate road section is traversed for the first time by a networked vehicle, such as the first vehicle, the GPS data and the detected object, in particular including a property, such as class and position, are transmitted to the backend, received there by it, and recorded there. Subsequent vehicles, such as a second vehicle, also send their detection results, The backend aggregates the locations or positions and the results of the whole vehicle fleet, and uses this to generate performance statistics for the different vehicles and, in particular, different vehicle generations and, accordingly, sensor-device generations, For camera sensors, these statistics may include, e.g., detection rates of the individual traffic signs, as well as lane markings, especially as concerns availability, classification, geometric parameters, etc. The use of the networked vehicle fleet and continuous data collection over longer intervals prevents the statistics from being distorted by changing ancillary conditions, such as weather and visibility conditions, the obscuring of objects by other road users, etc. If the statistics vary greatly, then vehicle-fleet training data may be requested from the relevant road sections in order to improve the corresponding algorithm. Depending on the development stage, the training data may be used to optimize a feature currently under development and/or a subsequent update via customer service. The described method can then be reused in order to verify the optimized algorithm.

In particular, the method according to the invention provides a cross-vehicle data feature, which data are initially provided by the respective sensor device, also referred to as environment sensor system, and characterize, e.g., the respective detected object. In particular, the respective sensor device may be designed as a camera system comprising at least one camera. By means of the respective camera, at least one respective sub-area of the respective vehicle environment may be detected by detecting or recording at least one image of the sub-area by the respective camera. The data is generated at different instances at a similar or same location, since the object is recorded at different instances at the same location, i.e., at the same geoposition, by the respective sensor device. The respective data are sent to the backend, in particular via a wireless or cordless communication interface, and processed there. The reference truth for the respective geopositions is generated in the backend by aggregating the numerous detection data of static objects, such as lane markings and traffic signs, from the vehicle fleet over a longer period of time, e.g., days, weeks or even months. Based on this reference truth, local or global performance statistics are compiled for the respective static object for the individual generations, variants and versions of the sensor equipment, e.g., for image processing systems. Performance statistics may be a recognition rate of traffic signs or lane availability. If significant errors or deviations of a specific sensor system are identified in the detection of certain objects, training data, in particular, raw sensor data, may be requested from the vehicle fleet in order to optimize the impaired features.

A second aspect of the invention relates to a system for checking vehicle sensor devices. The system according to the invention comprises a first vehicle of the vehicles, which has a first sensor of the sensor devices. The system according to the invention comprises a second vehicle of the vehicles, which has a second sensor of the sensor devices. In addition, the system includes a central electronic computing unit external to the vehicles, also referred to as the backend, which is designed to receive first data provided by the first vehicle. The first data characterize at least one property of a stationary object detected by the sensor device of the first vehicle, as well as a location of the earth-based object determined by the first vehicle. Furthermore, the computing device is designed to receive second data provided by the second vehicle, which characterize the at least one property of the stationary object detected by the second sensor device of the second vehicle and a or the location of the earth-based object determined by the second vehicle. Furthermore, the computing device is designed to check the sensor devices depending on the first data and the second data. Advantages and advantageous configurations of the first aspect of the invention are to be regarded as advantages and advantageous embodiments of the second aspect of the invention, and conversely.

A third aspect of the invention relates to an electronic computing device for checking vehicle sensor devices, wherein the central electronic computing device, which is external with respect to the vehicles, is designed to receive first data provided by a first vehicle of the vehicles, which data characterize at least one property of a stationary object detected by the sensor device of the first vehicle, and a location of the earth-based object determined by the first vehicle. Moreover, the computing device is designed to receive second data provided by the second vehicle, which characterize the at least one property of the stationary object detected by the second sensor device of the second vehicle and a or the location of the earth-based object determined by the second vehicle. What's more, the computing device is designed to check the sensor device depending on the first and second data. Advantages and advantageous embodiments of the first and second aspect of the invention are to be regarded as advantages and advantageous embodiments of the third aspect of the invention, and conversely.

The invention also comprises the combinations of the features of the described embodiments. The invention, furthermore, includes developments of the inventive system and of the inventive electronic computing device, which have the features already described in connection with the developments of the inventive method. For this reason, the corresponding developments of the inventive system and the inventive electronic computing device are not again described here.

Further advantages, features and details of the invention result from the following description of a preferred exemplary embodiment, and with reference to the drawing. The features and combinations of features mentioned above in the description, including the features and combinations of features mentioned below in the description of the figures and/or shown separately in the figures may be used in the respectively specified combination, as well as in other combinations or separately, without leaving the scope of the Invention.

In the drawings:

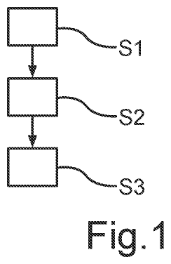

FIG. 1 is a flowchart illustrating a method according to the invention of checking vehicle sensor devices; and

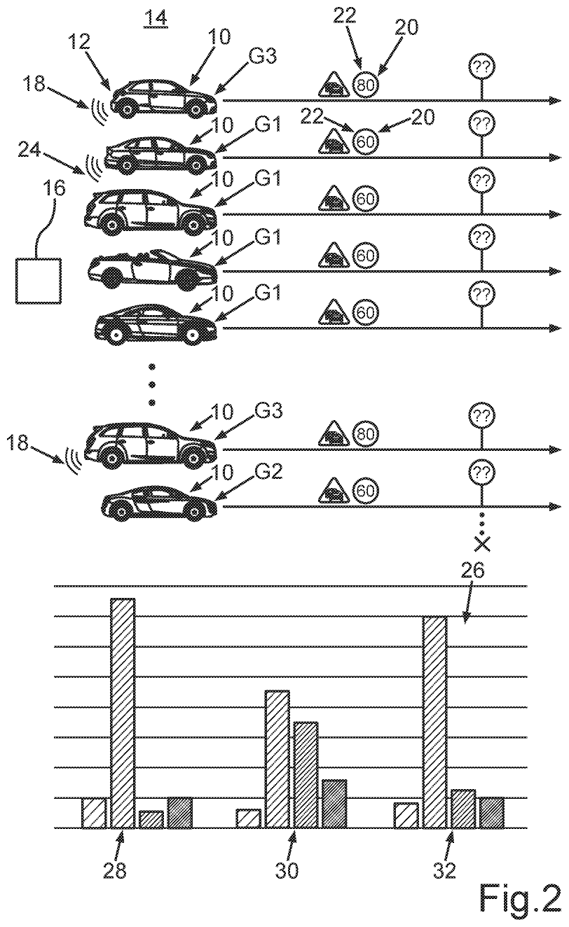

FIG. 2 is a schematic representation illustrating the method.

The exemplary embodiment explained below represents a preferred embodiment of the invention. In the exemplary embodiment, the described components of the embodiment represent individual features of the invention, which are to be considered independently of one another, and which further develop the invention independently of one another. For this reason, the disclosure should also include combinations of the features of the embodiment in addition to the ones described. In addition, further features of the invention described above may be added to the described embodiment.

Identical reference numerals in the figures indicate elements having identical functions.

FIG. 1 is a flow chart illustrating a method for checking vehicle (12) sensor devices 10 (FIG. 2). The vehicles 12 are designed as motor vehicles, i.e., passenger cars. The respective sensor device 10 is designed to detect at least a partial area of a respective environment 14 of the respective vehicle 12, in particular optically. Hence, the respective sensor device 10 comprises, e.g., at least one sensor, which may be designed as a radar sensor, a laser sensor, or a camera sensor, i.e., as a camera. Thus, the respective sensor device 10 is designed, e.g., to capture at least one image of the respective partial area.

In a first step S1 of the method, data 18 provided by a first vehicle 12 are initially received by a central electronic computing device 16, which is external to the vehicles 12, and also referred to as a backend. The first data 18 characterize at least one property 20 of a stationary object 22 detected by sensor device 10 of the first vehicle, as well as a location X of the earth-based object 22 detected by the first vehicle.

In a second step S2 of the method, second data 24 provided by a second vehicle 12 are detected or received by the electronic computing device 16, whereby the second data 24 characterizes the at least one property 20 of the object 22 and one location X of the earth-based object 22 determined by the second vehicle. If the locations determined by the vehicles 12, in particular by the sensor device 10, are equal, it can be concluded that a similar, in particular the same object 22 was detected by the sensor devices 10. Since a similar or the same property 20 is detected by the sensor devices 10, the sensor devices 10 can, e.g., be compared with one another particularly advantageously and subsequently checked, in particular evaluated. For example, vehicles 12 designated by G1 belong to a first generation, such that the sensor devices 10 of vehicles G1 belong to a first sensor-device type in the form of a first sensor-device generation, and are assigned to the first sensor-device type. For example, one of the vehicles 12 designated G2 belongs to a second generation, such that sensor device 10 of vehicle G2 belongs to a second sensor-device type in the form of a second sensor-device generation.

For example, one of the vehicles 12 designated G3 belongs to a third generation, such that sensor devices 10 of vehicle G3 belongs to a third sensor device type in the form of a third sensor-device generation. For example, sensor device 10 of vehicle G2 is assigned to the second sensor-device generation and sensor devices 10 of vehicle G3 is assigned to the third sensor-device generation. The sensor-device generations or sensor devices 10 of the sensor-device generations differ, e.g., in terms of their software and/or hardware generations, i.e., their software generation and/or their installed components. In a third step S3 of the method, the sensor devices 10 are checked depending on the first data 18 and the second data 24, in particular by the electronic computing device 16. For example, vehicles G1 provide second data 24, whereby vehicles G3 provide first data 18, and vehicles G2, e.g., provide third data.

In the example shown in the figures, object 22 is an actual traffic sign, which is physically present on the earth. Property 20 of the actual traffic sign has an actual expression in the form of an actual speed indication. The actual speed indication is a number which is, e.g., 60, thus indicating that the respective vehicle 12 may be driven at a maximum speed of 60 KPH.

Although a similar or the same property 20 is detected by the sensor devices 10, different expressions of property 20 may be detected by the sensor devices 10, in that the sensor devices 10 belong to different generations of sensor devices. For example, sensor devices 10 of the G1 vehicles detect that the expression of the property 20 is “60.” In contrast, the sensor devices 10 of the vehicles G3 comprise that the expression of the property 20 is “80.” Based on the vehicle (12) data 18 and 24, e.g., the backend is used to generate a statistic 26, also known as performance statistics, and illustrated in FIG. 2 by way of a bar chart. Columns 28 indicate, e.g., the numbers of sensor devices 10 belonging to the first sensor-device generation, which have not recognized the expression “50,” the expression “60,” the expression “80” of property 20 or the expression, at all. Accordingly, columns 30 of statistic 26 indicate for the second sensor-device generation the number of sensor devices 10 belonging to the second sensor-device generation which have not recognized the expression “50,” the expression “60,” the expression “80,” or the expression, at all.

Accordingly, e.g., columns 32 of statistic 26 indicate the number of sensor devices 10 belonging to the third sensor-device generation which have not in any way recognized the expression “50,” the expression “60,” the expression “80,” or the expression.

Columns 28, 30 and 32 thus illustrate the respective detection rates with which the respective sensor devices 10 belonging to the respective sensor-device generation have detected, i.e., recognized, the expression of at least one property 20. Columns 28 and 32 show that, e.g., the number of sensor devices 10 belonging to the first and third sensor-device generation 10, which have detected the expression “60.” is substantially greater than the number of sensor devices 10 that have detected the other expressions that are not “60.” The columns 30 show that the number of detected expressions that differ from one another is relatively similar in the second sensor-device generation. Thus, using statistic 26, a reference truth can subsequently be determined. Since a particularly high number of sensor devices has detected the expression “60,” the expression “60” is determined, e.g., as a reference truth, and thus as a reference expression corresponding to the actual expression. Sensor devices, which detect expressions of property 20 that differ from the reference expression are thus classified, such that these sensor devices cannot properly detect the actual expression. The detection rates illustrated in FIG. 2 represent thus, e.g., comparative data, which are obtained from the data 18 and 24. For example, the comparative data are compared with one another, such that the sensor devices 10 of the different generations of sensor devices can be compared with one another, and in particularly evaluated. [Translator's note: redundant text omitted]

As a result, it is possible, for example, to at least reduce or eliminate any differences in the capability of detecting the actual expression of property 20. Subsequently, a particularly advantageous driver assistance system and/or a particularly advantageous automated driving feature may be created by the respective sensor device 10, such that a particularly safe journey can be realized.

1-11. (canceled)

12. A method for checking vehicle sensor devices, comprising the steps of:
initial data detection provided by a first vehicle of the vehicles by a central electronic computing device external to the vehicles, wherein the first data characterize at least one property of a stationary object detected by the sensor device of the first vehicle and a location (X) of the earth-based object determined by the first vehicle (step S2);
second data detection provided by a second vehicle of the vehicles by the central electronic computing device external to the vehicles, wherein the second data characterize the at least one property of the same stationary object detected by the sensor device of the second vehicle and a location (X) of the earth-based object determined by the second vehicle (step S2); and
checking the sensor devices depending on the first data and the second data (step S3),
wherein it is detected that a first number of vehicle sensor devices detect a first expression of the at least one property of the object, wherein a second number of vehicle sensor devices, which is less than the first number, detect a second expression of the at least one property of the object, which is different from the first expression, and wherein
depending on the numbers, steps are taken in order to improve the sensor devices belonging to the second number in terms of their ability to detect the at least one property.

13. The method according to claim 12, wherein the sensor device of the first vehicle is assigned to a first sensor-device type, and the sensor device of the second vehicle is assigned to a second sensor-device type, which is different from the first sensor-device type, wherein the sensor device types differ from one another with respect to their software generations and/or their components.

14. The method according to claim 12, wherein comparison data are first generated from the first data, and second comparison data are generated from the second data, wherein the comparison data are compared with one another, and wherein the sensor devices are checked depending on the comparison of the comparison data.

15. The method according to claim 14, wherein training data of at least one of the sensor devices are requested by the electronic computing device depending on the comparison of the vehicle comparison data including the at least one sensor device.

16. The method according to claim 15, wherein the training data requested and provided as a result of the request by the vehicle including the at least one sensor device are received by means of the electronic computing device.

17. The method according to claim 16, wherein depending on the received training data, data for updating the at least one sensor device are transmitted from the electronic computing device to the vehicle including the at least one sensor device.

18. The method according to claim 12, wherein the property includes at least one speed limit and/or at least one lane marking.

19. The method according to claim 15, wherein the property includes at least one speed limit and/or at least one lane marking.

20. The method according to claim 12, wherein the first vehicle and the second vehicle exchange vehicle data, in particular directly with one another, wherein both vehicles transmit the associated data to the electronic computing device depending on the exchange of vehicle data.

21. The method according to claim 15, wherein the first vehicle and the second vehicle exchange vehicle data, in particular directly, with one another, wherein both vehicles transmit the associated data to the electronic computing device depending on the exchange of vehicle data.

22. The method according to claim 18, wherein the first vehicle and the second vehicle exchange vehicle data, in particular directly, with one another, wherein both vehicles transmit the associated data to the electronic computing device depending on the exchange of vehicle data.

23. The method according to claim 20, wherein the first vehicle and the second vehicle exchange vehicle data, in particular directly, with one another, wherein both vehicles transmit the associated data to the electronic computing device depending on the exchange of vehicle data.

24. A system for checking vehicle sensor devices, comprising:
a first vehicle of the vehicles, which has a first sensor of the sensor devices;
a second vehicle of the vehicles which has a second sensor of the sensor devices; and
a central electronic computing device, which is external to the vehicles, and is designed to: receive first data provided by the first vehicle, which data characterize at least one property of a stationary object detected by the first sensor device of the same first vehicle, and a location (X) of the earth-based object determined by the first vehicle;
receive second data provided by the second vehicle, which characterize the at least one property of the stationary object detected by the second sensor device of the second vehicle, and a location (X) of the earth-based object determined by the second vehicle; and
check the sensor devices depending on the first data and the second data, wherein
the computing device is further designed to:
to recognize that a first number of the vehicle sensor devices detects a first expression of the at least one property of the object, wherein a second number of vehicle sensor devices, which is less than the first number, detects a second expression of the at least one property of the object, which expression differs from the first expression, and
depending on the numbers, steps are taken to improve the sensor devices belonging to the second number in terms of their ability to detect the at least one property.

25. An electronic computing device for checking vehicle sensor devices, wherein the central electronic computing device, which is external to the vehicles, is designed to:
receive first data provided by a first vehicle of the vehicles, which characterize at least one property of a stationary object detected by the sensor device of the first vehicle, and a location (X) of the earth-based object determined by the first vehicle;
receive second data provided by a second vehicle of the vehicles, which characterize the at least one property of the same stationary object detected by the second vehicle sensor device, and a location (X) of the earth-based object determined by the second vehicle; and
check the sensor devices depending on the first data and the second data wherein the computing device is further designed to:
recognize that a first number of the vehicle sensor devices detects a first expression of the at least one property of the object, wherein a second number of vehicle sensor devices, which is less than the first number, detects a second expression of the at least one property of the object, which expression is different from the first expression, and
depending on their numbers, steps are taken in order to improve the sensor devices belonging to the second number in terms of their ability to detect the at least one property.

26. The method according to claim 13, wherein comparison data are first generated from the first data, and second comparison data are generated from the second data, wherein the comparison data are compared with one another, and wherein the sensor devices are checked depending on the comparison of the comparison data.

27. The method according to claim 13, wherein the property includes at least one speed limit and/or at least one lane marking.

28. The method according to claim 16, wherein the property includes at least one speed limit and/or at least one lane marking.

29. The method according to claim 17, wherein the property includes at least one speed limit and/or at least one lane marking.

30. The method according to claim 13, wherein the first vehicle and the second vehicle exchange vehicle data, in particular directly with one another, wherein both vehicles transmit the associated data to the electronic computing device depending on the exchange of vehicle data.

31. The method according to claim 16, wherein the first vehicle and the second vehicle exchange vehicle data, in particular directly, with one another, wherein both vehicles transmit the associated data to the electronic computing device depending on the exchange of vehicle data.
